(19) United States
(12) Patent Application Publication
(10) Pub. No.: US 2025/0193931 A1
(43) Pub. Date: Jun. 12, 2025

(54) ENHANCED WI-FI ULTRA-LOW LATENCY OPERATIONS

(71) Applicant: INTEL CORPORATION, Santa Clara, CA (US)

(72) Inventors: Juan FANG, Portland, OR (US); Shahrnaz AZIZI, Cupertino, CA (US); Laurent CARIOU, Milizac (FR); Dave CAVALCANTI, Portland, OR (US); Xiaogang CHEN, Portland, OR (US); Thomas J. KENNEY, Portland, OR (US); Minyoung PARK, San Ramon, CA (US); Javier PEREZ-RAMIREZ, North Plains, OR (US); Timothy F. COX, Palo Alto, CA (US); Jeffrey FOERSTER, Portland, OR (US)

(73) Assignee: INTEL CORPORATION, Santa Clara, CA (US)

(21) Appl. No.: 18/840,789

(22) PCT Filed: Mar. 31, 2022
(86) PCT No.: PCT/US2022/022959

§ 371 Date: Aug. 22, 2024

(51) Int. Cl. H04W 74/0816; H04L 5/00; H04W 74/04

(52) U.S. Cl. CPC H04W 74/0816; H04L 5/0053; H04W 74/04

(57) ABSTRACT

This disclosure describes systems, methods, and devices related to performing Wi-Fi low-latency operations. A multi-link device (MLD) may generate a first physical layer (PHY) protocol data unit (PPDU); transmit, using a first station device of the MLD, the first PPDU during a transmission opportunity (TXOP) for the first station device of the MLD and a second station device of a second MLD; identify a frame received by the first station device after transmission of the first PPDU indicating a request for the second station device or a third station device to transmit time-sensitive data to the first station device; identify time-sensitive data received by the first station device after transmission of the first PPDU; transmit, using the first station device, an acknowledgement indicative of receipt of the time-sensitive data by the first station device; generate the second PPDU; and transmit, using the first station device, the second PPDU.

### TECHNICAL FIELD

This disclosure generally relates to systems and methods for wireless communications and, more particularly, to Wi-Fi ultra-low latency operations.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1A is a network diagram illustrating an example network environment, in accordance with one or more example embodiments of the present disclosure.

FIG. 1B depicts an illustrative schematic diagram for multi-link device (MLD) communications between two logical entities, in accordance with one or more example embodiments of the present disclosure.

FIG. 1C depicts an illustrative schematic diagram for MLD communications between an access point (AP) MLD with logical entities and a non-AP MLD with logical entities, in accordance with one or more example embodiments of the present disclosure.

FIG. 2A shows example downlink (DL) transmission opportunities (TXOPs) using Wi-Fi MLDs and block acknowledgements, in accordance with one or more example embodiments of the present disclosure.

FIG. 2B shows example uplink (UL) TXOPs using Wi-Fi MLDs and block acknowledgements, in accordance with one or more example embodiments of the present disclosure.

FIG. 3A shows example time-sensitive transmissions during DL TXOPs using Wi-Fi MLDs and block acknowledgements, in accordance with one or more example embodiments of the present disclosure.

FIG. 3B shows example time-sensitive transmissions during DL TXOPs using Wi-Fi MLDs and block acknowledgements, in accordance with one or more example embodiments of the present disclosure.

FIG. 4A shows example time-sensitive transmissions during UL TXOPs using Wi-Fi MLDs and block acknowledgements, in accordance with one or more example embodiments of the present disclosure.

FIG. 4B shows example time-sensitive transmissions during DL TXOPs using Wi-Fi MLDs, block acknowledgements, and smaller preambles, in accordance with one or more example embodiments of the present disclosure.

FIG. 5 illustrates a flow diagram of illustrative process for Wi-Fi ultra-low latency operations, in accordance with one or more example embodiments of the present disclosure.

FIG. 6 illustrates a functional diagram of an exemplary communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

FIG. 8 is a block diagram of a radio architecture in accordance with some examples.

FIG. 9 illustrates an example front-end module circuitry for use in the radio architecture of FIG. 8, in accordance with one or more example embodiments of the present disclosure.

FIG. 10 illustrates an example radio IC circuitry for use in the radio architecture of FIG. 8, in accordance with one or more example embodiments of the present disclosure.

FIG. 11 illustrates an example baseband processing circuitry for use in the radio architecture of FIG. 8, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

In multi-link communications, a multi-link device (MLD), also referred to as a multi-link logical entity (MLLE), may refer to a device that has more than one affiliated STA and that has a medium access control (MAC) layer (e.g., of a communication layer stack) service access point (SAP) to a logical link control (LLC), which may include a MAC data service. An AP MLD (A MLD) may refer to an AP device, where each STA affiliated with the STA MLD is an AP STA. A non-AP MLD device (non-AP MLD) maybe an MLD, where each STA affiliated with the MLD is a non-AP STA. A MLD may be considered a logical/virtual entity with multiple STAs (e.g., AP STAs or non-AP STAs), and each STA concurrently may use separate communication links with corresponding STAs of another MLD. In this manner, a MLD may communicate over multiple communication links concurrently without having to drop one communication link to allow for establishing another communication link.

To increase the overall throughput of Wi-Fi devices, the concepts of a transmission opportunity (TXOP) and frame aggregation were introduced in the IEEE 802.11n standard and in subsequent 802.11 standards. TXOP is a function of the medium access control (MAC) layer of the Open Systems Interconnection (OSI) communication stack. A TXOP may define a contention-free time period during which a device may transmit after gaining access to a transmission medium. Frame aggregation allows for aggregating multiple frames in a transmission, and results in a larger physical layer (PHY) protocol data unit (PPDU) data payload that uses longer airtime.

TXOPs may be extended to MLDs. In particular, the STAs as logical entities of an MLD may have their own respective TXOPs scheduled with other STAs. In this manner, a MLD may have multiple STAs, each having its own scheduled TXOPs. The TXOPs of the STAs of a single MLD may overlap because the STAs of the same MLD may use different communication links.

While frame aggregation helps improve throughput and reduce average latency for a pair of STAs (e.g., MLD STAs), it can result in a much higher worst-case latency for a third party STA waiting for the wireless medium to be idle due to a much longer airtime occupied by a long aggregated PPDU between the pair of STAs. Time-sensitive frames may experience a higher latency if the channel is occupied by a long PPDU transmission by other devices from the same basic service set (BSS) or overlapping BSS (OBSS).

Some techniques to facilitate ultra-low latency operations during a TXOP may include dividing the TXOP into multiple smaller PPDU transmission intervals, resulting in time in between the PPDU transmissions during which a time-sensitive transmission may occur. However, such techniques may result in spectrum efficiency loss with a legacy preamble included at the beginning of each PPDU transmission.

There is therefore a need for enhanced ultra-low latency Wi-Fi operations.

In one or more embodiments, when a TXOP is divided into multiple smaller PPDU transmission intervals, a synchronized TXOP (S-TXOP) may be introduced to reduce the overhead of PPDU transmissions during the TXOP while enabling ultra-low latency time-sensitive transmissions and maintaining high throughput for larger PPDU transmissions during the TXOP. The enhanced techniques may be implemented with or without block acknowledgements. The enhanced techniques may reduce the worst-case latency for ultra-low latency applications transmitting smaller packets while Wi-Fi operation channels are being occupied with long TXOP data transmissions by other STAs (e.g., of MLDs) within a BSS. Low-latency and reliable communications are some of the main gaps in existing Wi-Fi radios (including 802.11ax), and there is an opportunity to address these problems in next generation Wi-Fi standards, 802.11be (Wi-Fi 7), or in Wi-Fi 8, with multiple link or other new capabilities. The mechanisms described herein will enable a low-latency application for small packets in 802.11 while all the operation channels are being occupied by another transmission.

In one or more embodiments, TXOPs between STAs of an A-MLD and a MLD may allow for downlink (DL) PPDU transmissions from a STA of the A-MLD to a STA of the MLD, and may allow for uplink (UL) PPDU transmissions from a STA of the MLD to a STA of the A-MLD. In between the respective PPDU transmissions of a TXOP (e.g., during a short inter frame space time), the respective STAs may send and receive block acknowledgements. For example, after a DL PPDU is transmitted, a STA of a MLD may transmit a block acknowledgement to the STA of the A-MLD, and after a UL PPDU is transmitted (e.g., in response to a trigger frame sent by the STA of the A-MLD), the STA of the A-MLD may send a block acknowledgement to the STA of the MLD. Alternatively, a single block acknowledgement may be sent by the STA that receives the PPDU after all PPDU transmissions are complete in a TXOP.

In one or more embodiments, in a downlink PPDU TXOP, the STA of the MLD that sends the block acknowledgement after a PPDU TXOP transmission may integrate an ultra-low latency time-sensitive packet with the block acknowledgement, and send the integrated packet to the STA of the A-MLD. When there is no block acknowledgement after a PPDU TXOP transmission, the STA of the MLD may send a suspend request (SR) control frame in between the TXOP PPDUs. Upon receipt of a SR control frame, the STA of the A-MLD may send a trigger frame to trigger the STA of the MLD to send an ultra-low latency time-sensitive packet or to integrate signaling information within a subsequent DL PPDU to inform the STA of the MLD that it may send the time-sensitive packet after reception of the DL PPDU. Due to the insertion of the time-sensitive packet transmission, the number of bytes that can be transmitted within the reserved TXOP may need to be adjusted. In one or more embodiments, during a DL TXOP, other STAs may transmit the UL time-sensitive packet.

In one or more embodiments, during a DL PPDU transmission during a TXOP, if other STAs have a time-sensitive packet to be transmitted, any of the STAs may transmit a SR control frame after the DL PPDU transmission or a UL block acknowledgement frame (e.g., when block acknowledgements are sent after DL PPDU transmissions). The SR control frame may last around 8 microseconds, and may be designed with a new PHY waveform. The STA of the A-MLD may suspend the next subsequently scheduled DL PPDU transmission, and instead may transmit a trigger frame to trigger the STA of the MLD to transmit the UL time-sensitive packet. Alternatively, the STA of the A-MLD may continue the following scheduled DL PPDU transmission, and suspend a subsequent DL PPDU transmission to send the trigger frame. Alternatively, the STA of the A-MLD may ignore an SR control frame from the STA of the MLD when the STA of the MLD has not negotiated with the A-MLD for the preemption of a DL PPDU TXOP transmission.

In one or more embodiments, during a UL TXOP, when a STA of an A-MLD has a DL time-sensitive packet to send to the same STA sending the UL PPDU, the UL TXOP may be divided into multiple UL PPDU transmissions. During a UL PPDU transmission, when a STA of an A-MLD has a DL time-sensitive packet to send to the same STA sending the UL PPDU, the STA of the A-MLD may integrate the time-sensitive packet into a block acknowledgement to send to the STA of the MLD after the UL PPDU transmission. When block acknowledgements are not used, the STA of the A-MLD may send a SR control frame after a UL PPDU transmission, and then may send the time-sensitive packet if the channel is idle after the SR control frame. Upon reception of a SR control frame by the STA of the MLD, the STA of the MLD may suspend UL PPDU transmission until the STA of the A-MLD sends a trigger frame. The number of bytes transmitted within a TXOP may need to be adjusted accordingly.

In one or more embodiments, during a UL TXOP in which another STA has a time-sensitive packet to transmit, a UL STA of the MLD may adjust the timing or frequency based on the trigger frame or block acknowledgement frame to send the time-sensitive packet over null tones.

In one or more embodiments, UL/DL long TXOP transmission with multiple PPDUs or PPDU/BA (block acknowledgement) exchanges enables a Wi-Fi network to support both long TXOP transmissions to achieve high throughput, and also low-latency for time-critical (TC, also referred to as time-sensitive) packet transmission, however, it may be at the cost of high overhead due to the legacy preamble. Leveraging the idea of S-TXOP (e.g., with a “light” preamble) may reduce the overhead caused by the legacy preamble. For example, the preamble for non-first DL PPDU or non-first DL PPDU after DL data transmission suspension may be replaced with a light-preamble (e.g., ˜1-2 OFDM symbols or without legacy preamble).

In one or more embodiments, the enhancements herein allowing for time-sensitive transmissions in between scheduled PPDU transmissions during a TXOP between MLDs may reduce overhead and delay for the time-sensitive transmissions, resulting in lower latency and more efficient Wi-Fi operations.

The above descriptions are for purposes of illustration and are not meant to be limiting. Numerous other examples, configurations, processes, algorithms, etc., may exist, some of which are described in greater detail below: Example embodiments will now be described with reference to the accompanying figures.

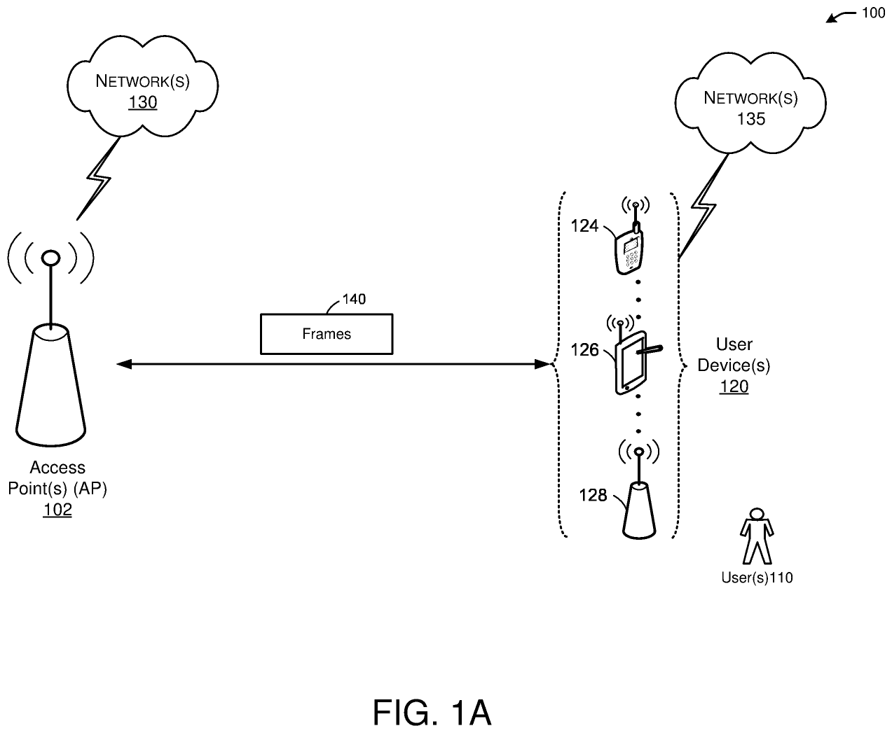

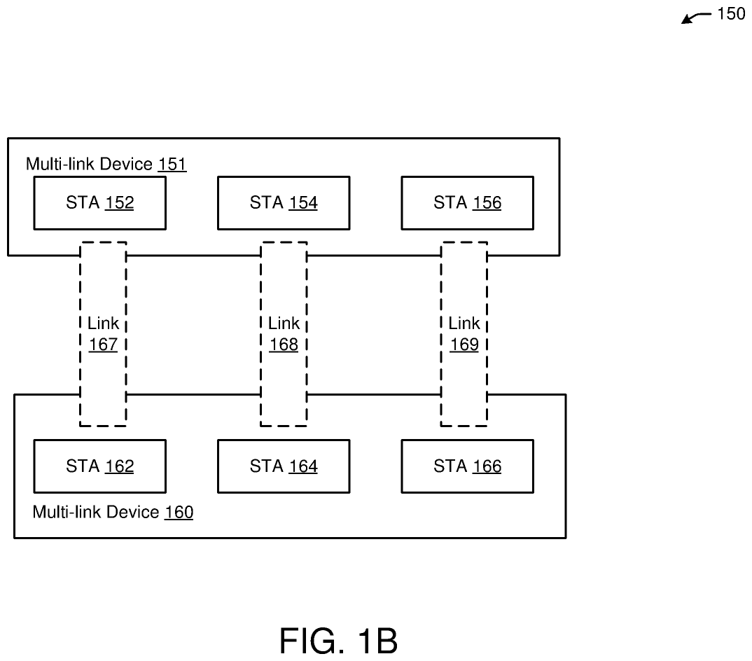

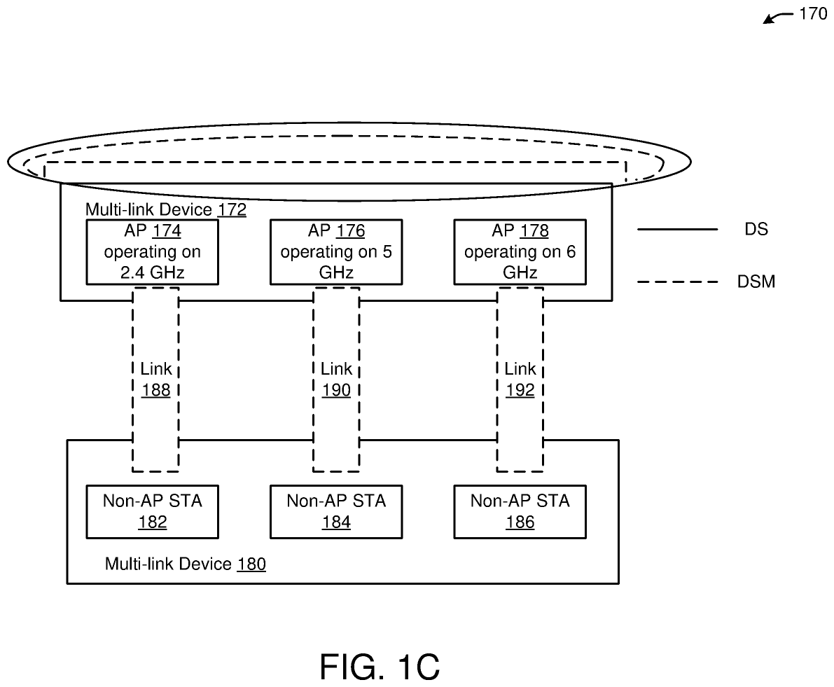

FIG. 1 is a network diagram illustrating an example network environment 100, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

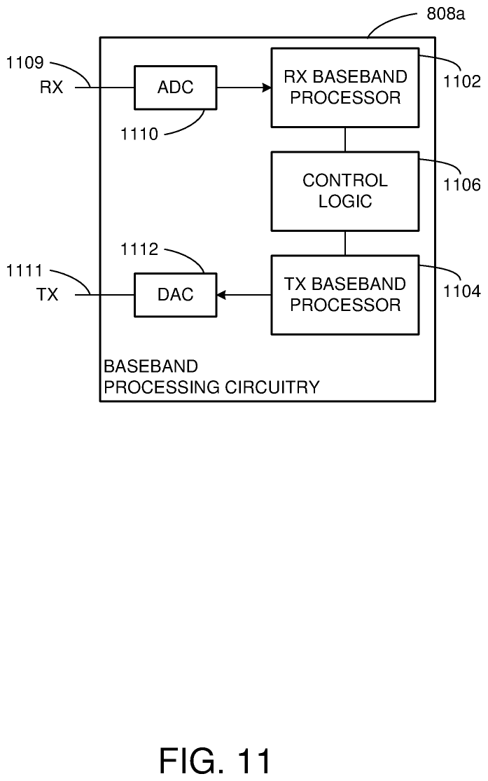

In some embodiments, the user devices 120 and the AP 102 may include one or more computer systems similar to that of the functional diagram of FIG. 11 and/or the example machine/system of FIG. 12.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHZ channels (e.g. 802.11b, 802.11g, 802.11n, 802.11ax), 5 GHZ channels (e.g. 802.11n, 802.11ac, 802.11ax), 60 GHZ channels (e.g. 802.11ad, 802.11ay, 802.11bf), and/or 800 MHZ channels (e.g. 802.11ah). The communications antennas may operate at 28 GHZ and 40 GHZ. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the user devices 120 may exchange frames 140 with the APs 102. The frames 140 may include DL PPDUs, UL PPDUs, block acknowledgements, trigger frames, time sensitive frames (e.g., integrated into other frames or sent separately), acknowledgement frames, SR control frames, and the like.

In one or more embodiments, any of the user devices 120 (e.g., user devices 124, 126, 128), and AP(s) 102 may be MLDs (e.g., the AP 102 may be an A-MLD, and the user devices 124, 126, 128 may be MLDs).

It is understood that the above descriptions are for purposes of illustration and are not meant to be limiting.

FIG. 1B depicts an illustrative schematic diagram 150 for MLD communications between two logical entities, in accordance with one or more example embodiments of the present disclosure.

Referring to FIG. 1B, there are shown two MLDs in communication with each other. MLD 151 may include multiple STAs (e.g., STA 152, STA 154, STA 156, etc.), and MLD 160 may include multiple STAs (e.g., STA 162, STA 164, STA 166, etc.). The STAs of the MLD 151 and the STAs of the MLD 160 may set up links with each other (e.g., link 167 for a first frequency band used by the STA 152 and the STA 162, link 168 for a second frequency band used by the STA 154 and the STA 164, link 169 for a second frequency band used by the STA 156 and the STA 166). In this example of FIG. 1B, the two MLDs may be two separate physical devices, where each one comprises a number of virtual or logical devices (e.g., the STAs).

FIG. 1C depicts an illustrative schematic diagram 170 for MLD communications between an AP MLD with logical entities and a non-AP MLD with logical entities, in accordance with one or more example embodiments of the present disclosure.

Referring to FIG. 1C, there are shown two MLDs on either side, each which includes multiple STAs that can set up links with each other. For infrastructure framework, MLD 172 may be an A-MLD with logical APs (e.g., AP 174, AP 176, and AP 178) on one side, and MLD 180 may be a non-AP MLD including non-AP logical entities (non-AP STA 182, non-AP STA 184, and non-AP STA 186) on the other side. The detailed definition is shown below. It should be noted that the term MLLE and MLD are interchangeable and indicate the same type of entity. Throughout this disclosure, MLLE may be used but anywhere the MLLE term is used, it can be replaced with MLD. Multi-link non-AP logical entity (non-AP MLLE, also can be referred to as non-AP MLD): A multi-link logical entity, where each STA within the multi-link logical entity is a non-AP EHT STA. It should be noted that this framework is a natural extension from the one link operation between two STAs, which are AP and non-AP STA under the infrastructure framework (e.g., when an AP is used as a medium for communication between STAs).

In the example of FIG. 1C, the MLD 172 and the MLD 180 may be two separate physical devices, where each one comprises a number of virtual or logical devices. For example, the multi-link AP logical entity may comprise three APs, AP 174 operating on 2.4 GHz (e.g., link 188), AP 176 operating on 5 GHZ (e.g., link 190), and AP 178 operating on 6 GHz (e.g., link 192). Further, the multi-link non-AP logical entity may comprise three non-AP STAs, non-AP STA 182 communicating with AP 174 on link 188, non-AP STA 184 communicating with AP 176 on link 190, and non-AP STA 186 communicating with AP 178 on link 192.

The MLD 172 is shown in FIG. 1C to have access to a distribution system (DS), which is a system used to interconnect a set of BSSs to create an extended service set (ESS). The MLD 172 is also shown in FIG. 1C to have access a distribution system medium (DSM), which is the medium used by a DS for BSS interconnections. Simply put, DS and DSM allow the AP to communicate with different BSSs.

It should be understood that although the example shows three logical entities within the MLD 172 and the three logical entities within the MLD 180, this is merely for illustration purposes and that other numbers of logical entities with each of the MLDs may be envisioned.

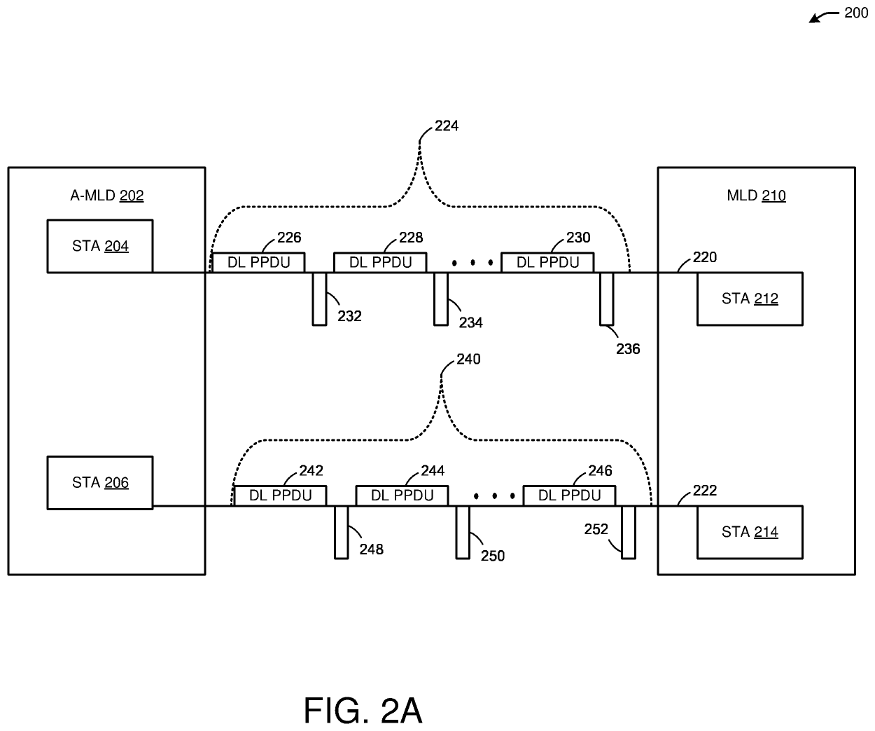

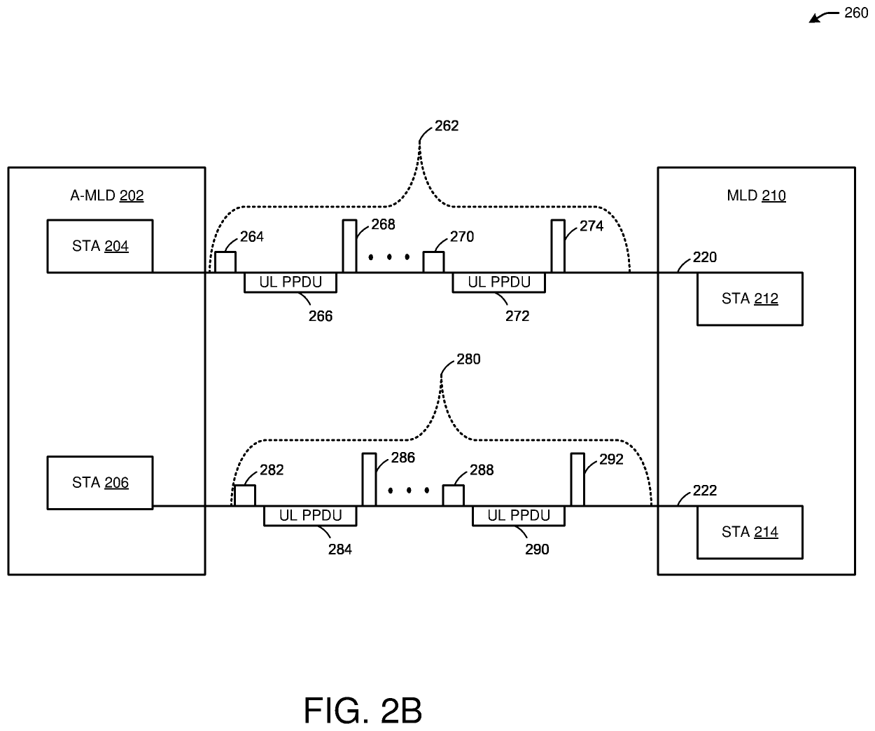

FIG. 2A shows example downlink (DL) transmission opportunities (TXOPs) 200 using Wi-Fi MLDs and block acknowledgements, in accordance with one or more example embodiments of the present disclosure.

Referring to FIG. 2A, an A-MLD 202 with STA 204 and STA 206 may communicate with a MLD 210. For example, the STA 204 may communicate with STA 212 of the MLD 210 via a communication channel 220, and the STA 206 may communicate with STA 214 of the MLD 210 via a communication channel 222. The STA 204 and the STA 212 may have a scheduled TXOP 224 using the communication channel 220. During the TXOP 224, the STA 204 may send DL PPDUs (e.g., DL PPDU 226, DL PPDU 228, DL PPDU 230, etc.). In this manner, the TXOP 224 may be divided into multiple transmissions, allowing for some time between the DL PPDU transmissions. During the times in between the DL PPDU transmissions during the TXOP 224, the STA 212 may send block acknowledgements to the STA 204 to indicate receipt of the respective DL PPDUs (e.g., block acknowledgement 232 may indicate receipt of the DL PPDU 226, block acknowledgement 234 may indicate receipt of the DL PPDU 228, block acknowledgement 236 may indicate receipt of the DL PPDU 230, etc.).

Still referring to FIG. 2A, the STA 206 and the STA 214 may have a scheduled TXOP 240) using the communication channel 222. During the TXOP 240, the STA 206 may send DL PPDUs (e.g., DL PPDU 242, DL PPDU 244, DL PPDU 246, etc.). In this manner, the TXOP 240) may be divided into multiple transmissions, allowing for some time between the DL PPDU transmissions. During the times in between the DL PPDU transmissions during the TXOP 240, the STA 214 may send block acknowledgements to the STA 206 to indicate receipt of the respective DL PPDUs (e.g., block acknowledgement 248 may indicate receipt of the DL PPDU 242, block acknowledgement 250) may indicate receipt of the DL PPDU 244, block acknowledgement 252 may indicate receipt of the DL PPDU 246, etc.).

In one or more embodiments, while FIG. 2A shows respective block acknowledgements sent after each DL PPDU during a TXOP, the multiple block acknowledgements may be replaced by a single block acknowledgement sent after all DL PPDUs are sent during a TXOP.

FIG. 2B shows example uplink (UL) TXOPs 260 using Wi-Fi MLDs and block acknowledgements, in accordance with one or more example embodiments of the present disclosure.

Referring to FIG. 2B, the A-MLD 202 and the MLD 210 of FIG. 2A may communicate with one another using the communication channel 220 and the communication channel 222 as shown in FIG. 2A. The STA 204 and the STA 212 may have a scheduled TXOP 262 using the communication channel 220. During the TXOP 262, the STA 204 may send a trigger frame 264 to the STA 212 to trigger the STA 212 to send a UL PPDU 266. After receipt of the UL PPDU 266, the STA 204 may send a block acknowledgment 268 to the STA 212 to indicate receipt of the UL PPDU 266. This process may repeat during the TXOP 262. For example, the STA 204 may send a trigger frame 270, and in response, the STA 212 may send a UL PPDU 272, and in response, the STA 204 may send a block acknowledgement 274.

Still referring to FIG. 2B, the STA 206 and the STA 214 may have a scheduled TXOP 280 using the communication channel 220. During the TXOP 280, the STA 206 may send a trigger frame 282 to the STA 214 to trigger the STA 214 to send a UL PPDU 284. After receipt of the UL PPDU 284, the STA 206 may send a block acknowledgment 286 to the STA 214 to indicate receipt of the UL PPDU 284. This process may repeat during the TXOP 280. For example, the STA 206 may send a trigger frame 288, and in response, the STA 214 may send a UL PPDU 290, and in response, the STA 206 may send a block acknowledgement 286.

In one or more embodiments, with reference to FIGS. 2A and 2B, the block acknowledgements may be integrated with TC data (e.g., a combined block acknowledgement and TC data transmission).

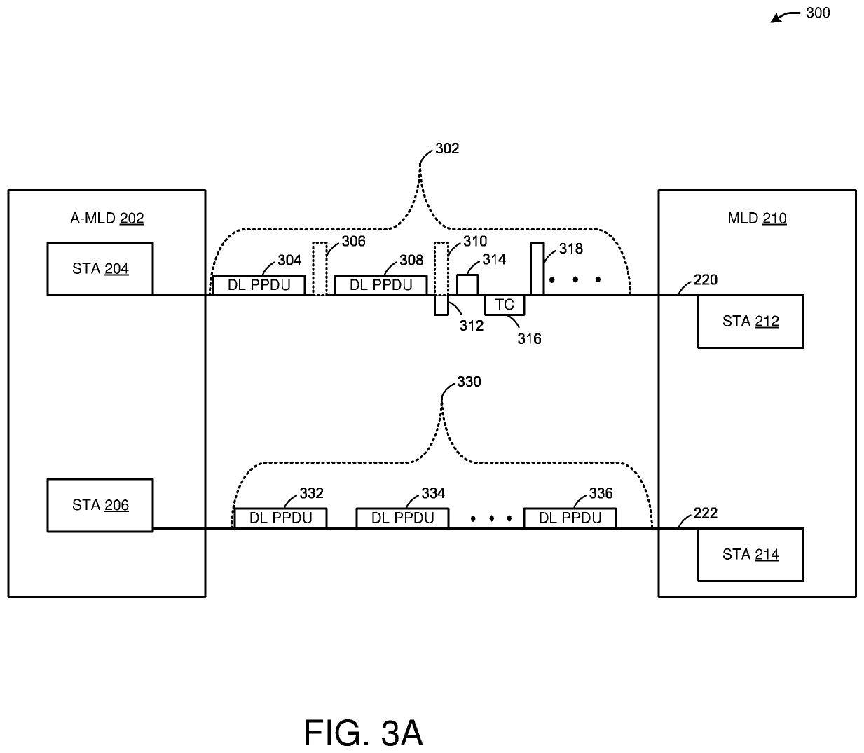

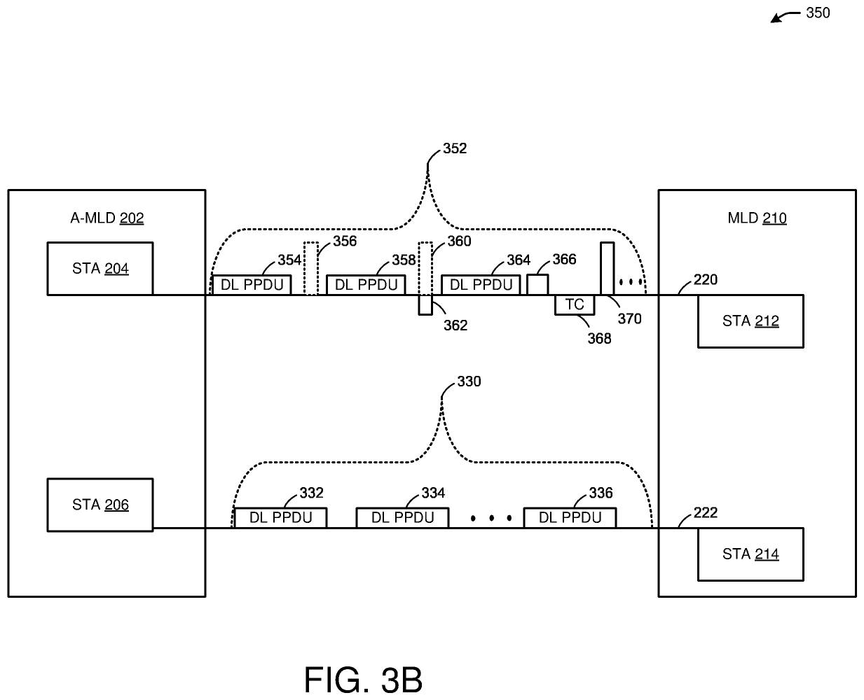

FIG. 3A shows example time-sensitive transmissions 300 during DL TXOPs using Wi-Fi MLDs and block acknowledgements, in accordance with one or more example embodiments of the present disclosure.

Referring to FIG. 3A, the A-MLD 202 and the MLD 210 of FIG. 2A may communicate with one another using the communication channel 220 and the communication channel 222 as shown in FIG. 2A. The STA 204 may have a scheduled TXOP 302 with the STA 212 using the communication channel 220. During the TXOP 302, the STA 204 may send a DL PPDU 304, and then may listen 306 (e.g., detect) for a SR control frame from the STA 212. The STA 204 may listen 306 for a short inter frame space (e.g., ˜8 microseconds). When no SR control frame is detected during that time, the STA 204 may continue the TXOP 302 by sending a DL PPDU 308. After sending the DL PPDU 308, the STA 204 may listen 310 for an SR control frame. When an SR control frame 312 is detected in between DL PPDU transmissions (e.g., the SR control frame 312 indicating that TC data are to be transmitted to the STA 204), the STA 204 may use the next scheduled DL PPDU time during the TXOP 302, or a time of a subsequent DL PPDU during the TXOP 302, to transmit a trigger frame 314 to trigger the sending of TC data 316 during the TXOP 302. Upon receipt of the TC data 216, the STA 204 may send an acknowledgment 318 indicating receipt of the TC data 216 during the TXOP 302, and may continue to transmit subsequent DL PPDUs during the TXOP 302.

Still referring to FIG. 3A, the STA 206 may have a scheduled TXOP 330 with the STA 214 using the communication channel 222. During the TXOP 330, the STA 204 may send DL PPDUs (e.g., a DL PPDU 332, a DL PPDU 334, a DL PPDU 336, etc.).

In one or more embodiments, when block acknowledgements are not used, the SR control frame 312 may be sent instead during the time between DL PPDU transmissions to indicate the need to transmit the TC data 316. The trigger frame 314 may indicate that the STA 212 may send the TC data 316. Alternatively, the next DL PPDU sent by the STA 204 during the TXOP 302 may include signaling information to communicate to the STA 212 that the TC data 316 may be sent after the DL PPDU (e.g., short inter frame space time after the DL PPDU).

In one or more embodiments, while the TC data 316 are shown as sent by the STA 212, the TC data 316 instead may be sent by another STA (e.g., the STA 214 or another STA).

FIG. 3B shows example time-sensitive transmissions 350 during DL TXOPs using Wi-Fi MLDs and block acknowledgements, in accordance with one or more example embodiments of the present disclosure.

Referring to FIG. 3B, the A-MLD 202 and the MLD 210 of FIG. 2A may communicate with one another using the communication channel 220 and the communication channel 222 as shown in FIG. 2A. The STA 204 may have a scheduled TXOP 352 with the STA 212 using the communication channel 220. During the TXOP 352, the STA 204 may send a DL PPDU 354, then may listen 356 (e.g., to detect a SR control frame), then may send a DL PPDU 358, then may listen 356 (e.g., to detect a SR control frame). When the STA 204 detects a SR control frame 362 (e.g., indicative of TC data to be sent to the STA 204), the STA 204 may send another DL PPDU 364 prior to triggering the UL transmission of the TC data. For example, after the DL PPDU 364, the STA 204 may send a trigger frame 366 to trigger the TC data 368 to be sent to the STA 204. Upon receipt of the TC data 368, the STA 204 may send an acknowledgment 370) indicating receipt of the TC data 368, and then may continue with any subsequent DL PPDUs during the TXOP 352.

Still referring to FIG. 3B, the STA 206 may have the scheduled TXOP 330 with the STA 214 using the communication channel 222. During the TXOP 330, the STA 204 may send DL PPDUs (e.g., the DL PPDU 332, the DL PPDU 334, the DL PPDU 336, etc.).

In one or more embodiments, the STA 204 may ignore the SR control frame 362 if the STA 212 has not pre-negotiated with the STA 204 for the TC packet transmission requirement, or if the scheduled DL PPDU transmission cannot be preempted. SIFS (short inter frame space) time after the reception of the trigger frame 366 from the STA 204, the STA 212 may provide the TC data 368. SIFS time after transmission of the acknowledgement 370, the STA 204 may resume DL PPDU transmissions during the TXOP 352.

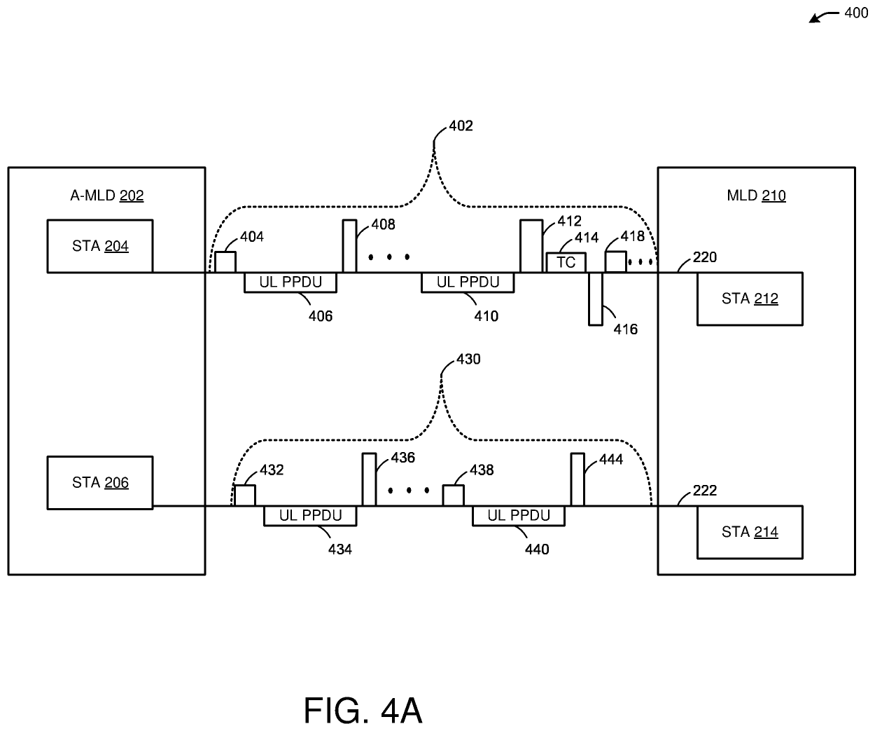

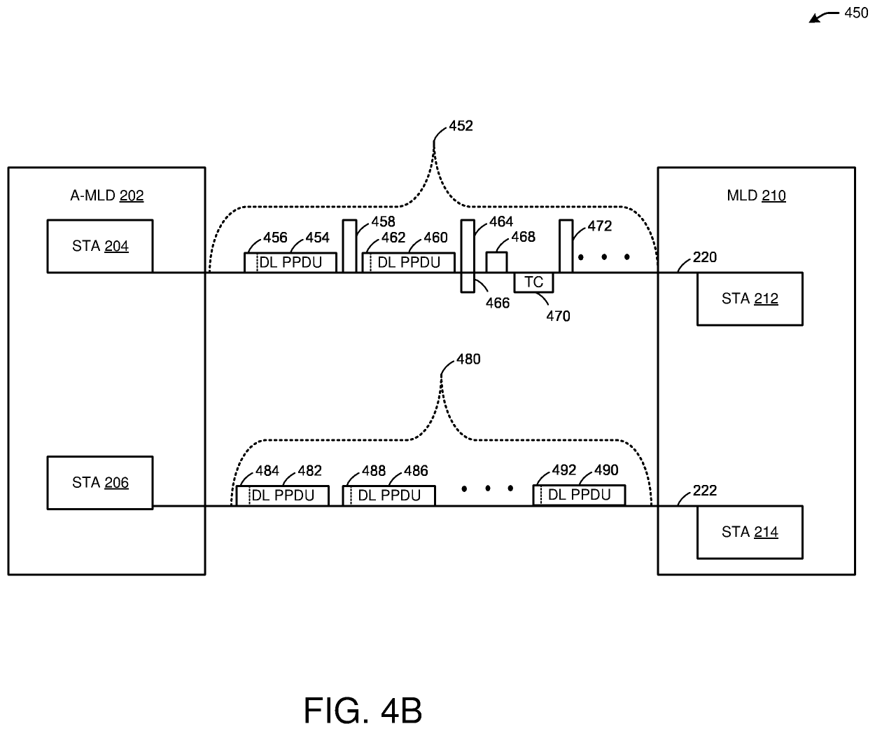

FIG. 4A shows example time-sensitive transmissions 400 during UL TXOPs using Wi-Fi MLDs and block acknowledgements, in accordance with one or more example embodiments of the present disclosure.

Referring to FIG. 4A, the A-MLD 202 and the MLD 210 of FIG. 2A may communicate with one another using the communication channel 220 and the communication channel 222 as shown in FIG. 2A. The STA 204 may have a scheduled TXOP 402 with the STA 212 using the communication channel 220. During the TXOP 402, the STA 204 may send a trigger frame 404 to trigger the STA 212 to send a UL PPDU 406. Upon receipt of the UL PPDU 406, the STA 204 may send an acknowledgment 408 to indicate receipt of the UL PPDU 406. The STA 204 may continue to send trigger frames to trigger UL PPDUs until the STA 204 identifies TC data to send during the TXOP 402. For example, after receipt of UL PPDU 410, the STA 204 may send a combined acknowledgment with SR control frame 412 to indicate that TC data 414 are to be sent by the STA 204. After the combined acknowledgment with SR control frame 412, the STA 204 may send the TC data 414. Upon receipt of the TC data 414, the STA 212 may send an acknowledgement 416 to indicate the receipt of the TC data 414. Then, the STA 204 may continue to send a trigger frame 418 to trigger a subsequent UL PPDU transmission.

Still referring to FIG. 4A, the STA 206 may have the scheduled TXOP 430 with the STA 214 using the communication channel 222. During the TXOP 430, the STA 204 may send a trigger frame 432 to trigger the sending of a UL PPDU 434, then may send an acknowledgement 436 (e.g., block acknowledgement), may send a trigger frame 438 to trigger the sending of a UL PPDU 440, then may send an acknowledgement 444 (e.g., block acknowledgement), and so on.

In one or more embodiments, during a UL PPDU transmission, if the STA 204 has TC data for the STA 212, the STA 204 may integrate the TC data with the acknowledgment and send it to the STA 212 (e.g., SIFS time after the reception of the UL PPDU 410). If there is no block acknowledgement after the UL PPDU 410, the STA 204 may send a SR control frame during the SIFS time between the two contiguous UL PPDUs, and send the TC data 414 if the communication channel 220 is idle for SIFS time after the transmission of the SR control frame. Upon the reception of the SR control frame, the STA 212 may suspend UL PPDU transmission until the STA 204 sends a trigger frame.

In one or more embodiments, during the UL PPDU transmission, if the STA 204 has TC data to send to other STAs, the STA 204 may transmit a SR control frame or SR control frame integrated with the block acknowledgement to the other STA SIFS time upon the reception of UL PPDU frame 410. Then SIFS time after the transmission of the SR control frame or SR control frame integrated with the BA frame, the STA 204 may send a the TC data 414 instead of waiting for the following UL PPDU as initially scheduled. SIFS time after reception of the acknowledgement 416, the STA 204 may trigger the STA 212 to resume the UL PPDU transmission.

FIG. 4B shows example time-sensitive transmissions 450 during DL TXOPs using Wi-Fi MLDs, block acknowledgements, and smaller preambles, in accordance with one or more example embodiments of the present disclosure.

Referring to FIG. 4B, the A-MLD 202 and the MLD 210 of FIG. 2A may communicate with one another using the communication channel 220 and the communication channel 222 as shown in FIG. 2A. The STA 204 may have a scheduled TXOP 452 with the STA 212 using the communication channel 220. During the TXOP 452, the STA 204 may send a DL PPDU 454 with a “normal” (e.g., legacy) preamble 456. After sending the DL PPDU 454, the STA 204 may listen 458 (e.g., for a SR control frame). When no SR control frame is detected, the STA 204 may send a DL PPDU 460. However, the DL PPDU 460 may have a “light” preamble 462 smaller than the normal preamble 456, or may have no preamble (e.g., the light preamble 462 may have zero symbols). After sending the DL PPDU 460, the STA 204 may listen 464 for a SR control frame. When the STA 204 detects a SR control frame 466, the STA 204 may suspend DL PPDU transmissions to allow for TC data transmission during the TXOP 452. For example, the STA 204 may send a trigger frame 468 to trigger transmission of TC data 470). Upon receipt of the TC data 470, STA 204 may send an acknowledgment 472 to indicate receipt of the TC data 470. After the acknowledgment 472, the STA 204 may continue with DL PPDU transmissions, starting again with a DL PPDU (e.g., the DL PPDU 454) having the normal preamble, and subsequently a DL PPDU (e.g., the DL PPDU 460) having a light preamble or no preamble.

Still referring to FIG. 4B, the STA 206 and the STA 214 may have a TXOP 480 using the communication channel 222. During the TXOP 480, the STA 206 may send a DL PPDU 482 having a normal preamble 484, then may send subsequent DL PPDUs with light preambles (e.g., DL PPDU 486 with light preamble 488, DL PPDU 490 with light preamble 492, etc.).

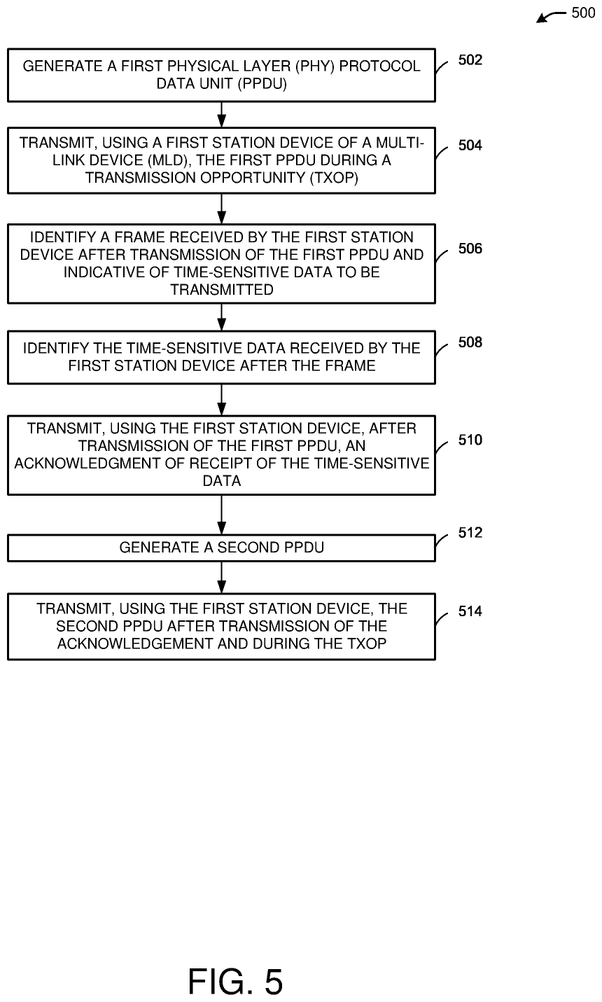

FIG. 5 illustrates a flow diagram of illustrative process 500 for Wi-Fi ultra-low latency operations, in accordance with one or more example embodiments of the present disclosure.

At block 502, a MLD (e.g., the A-MLD 202 or the MLD 210 of FIGS. 2A-4B) may generate a first PPDU to be sent during a TXOP. When the device is an A-MLD, the first PPDU may be a DL PPDU (e.g., the DL PPDU 226, 228, or 230 of FIG. 2A, the DL PPDU 304 or 308 of FIG. 3A, the DL PPDU 354, 358, or 364 of FIG. 3B, the DL PPDU 454 or 460 of FIG. 4B). When the device is a MLD, the first PPDU may be a UL PPDU (e.g., the UL PPDU 266 or 272 of FIG. 2B, the UL PPDU 406 or 410 of FIG. 4A).

At block 504, the MLD may transmit the first PPDU using a first station device (e.g., the STA 204 or the STA 212 of FIGS. 2A-4B) and a first communication channel (e.g., the communication channel 220 of FIGS. 2A-4B), and during a TXOP (e.g., the TXOP 224 of FIG. 2A, the TXOP 262 of FIG. 2B, the TXOP 302 of FIG. 3A, the TXOP 352 of FIG. 3B, the TXOP 402 of FIG. 4A, the TXOP 452 of FIG. 4B).

At block 506, the MLD may identify a frame received by the first station device after transmission of the first PPDU. The frame may indicate the presence of TC data to be sent to the first station device during the TXOP. The frame may be an SR control frame by itself, or an SR control frame integrated with another frame (e.g., with an acknowledgment frame). Upon receipt of the frame, the MLD may suspend UL or DL transmissions temporarily during the TXOP to allow for the TC data to be transmitted using the first communication channel. The MLD may send another UL PPDU or DL PPDU prior to the TC data being sent.

At block 508, the MLD may identify the TC data received by the first station device. When the TC data are DL TC data, the second station device may send the TC data after sending a SR control frame (e.g., FIG. 4A). When the TC data are UL data, the MLD may send a trigger frame to trigger the second station device or a third station device to send the TC data during the TXOP (e.g., FIGS. 3A, 3B, and 4B).

At block 510, the MLD may transmit an acknowledgment of receipt of the TC data. The acknowledgment may be a block acknowledgment. The acknowledgment may indicate receipt of the TC data, indicating that subsequent DL or UL PPDU transmissions may continue during the TXOP.

At block 512, the MLD may generate a second PPDU, either UL or DL, for transmission during the TXOP. At block 514, the first station device of the MLD may transmit the second PPDU after the acknowledgement and during the TXOP. The second PPDU may be transmitted before or after the TC data (e.g., when sent before the TC data, the first station device may send a third PPDU after the TC data transmission). In this manner, the TC data may be sent in between PPDU transmissions during a TXOP.

It is understood that the above descriptions are for purposes of illustration and are not meant to be limiting.

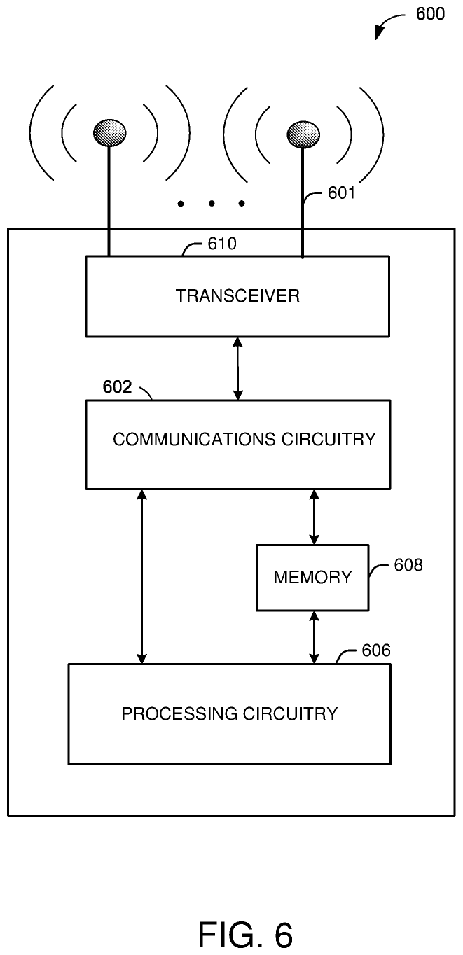

FIG. 6 shows a functional diagram of an exemplary communication station 600, in accordance with one or more example embodiments of the present disclosure. In one embodiment, FIG. 6 illustrates a functional block diagram of a communication station that may be suitable for use as an AP 102 (FIG. 1A) or a user device 120 (FIG. 1A) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device.

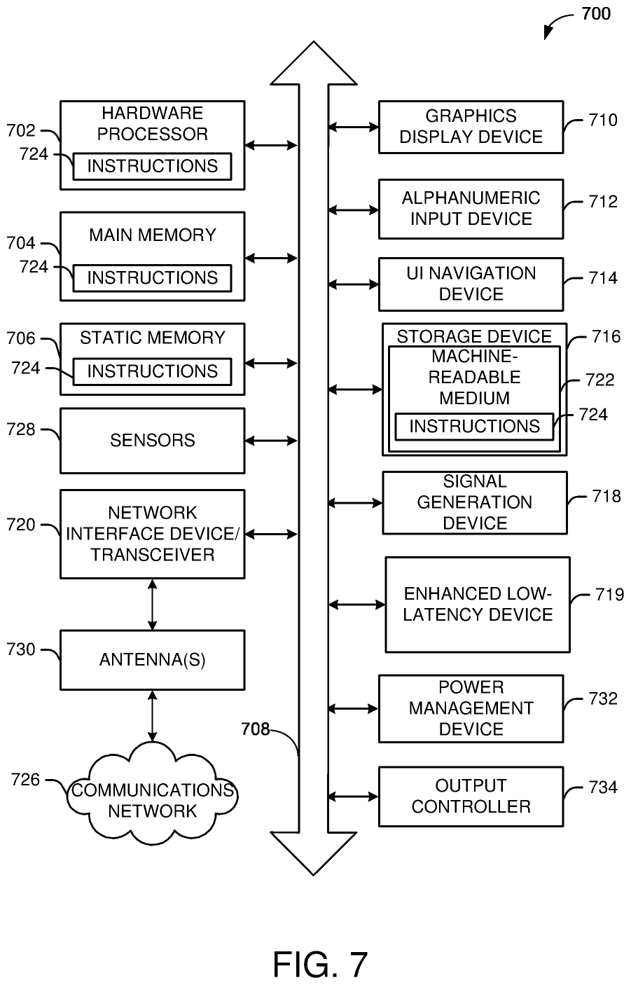

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), an enhanced low-latency device 719, a network interface device/transceiver 720) coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 704, the storage device 716, and/or the enhanced low-latency device 719. The baseband processor may be provided on a single radio card, a single chip, or an integrated circuit (IC).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The enhanced low-latency device 719 may carry out or perform any of the operations and processes (e.g., process 500)) described and shown above.

It is understood that the above are only a subset of what the enhanced low-latency device 719 may be configured to perform and that other functions included throughout this disclosure may also be performed by the enhanced low-latency device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM): random access memory (RAM): magnetic disk storage media: optical storage media: a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720) utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

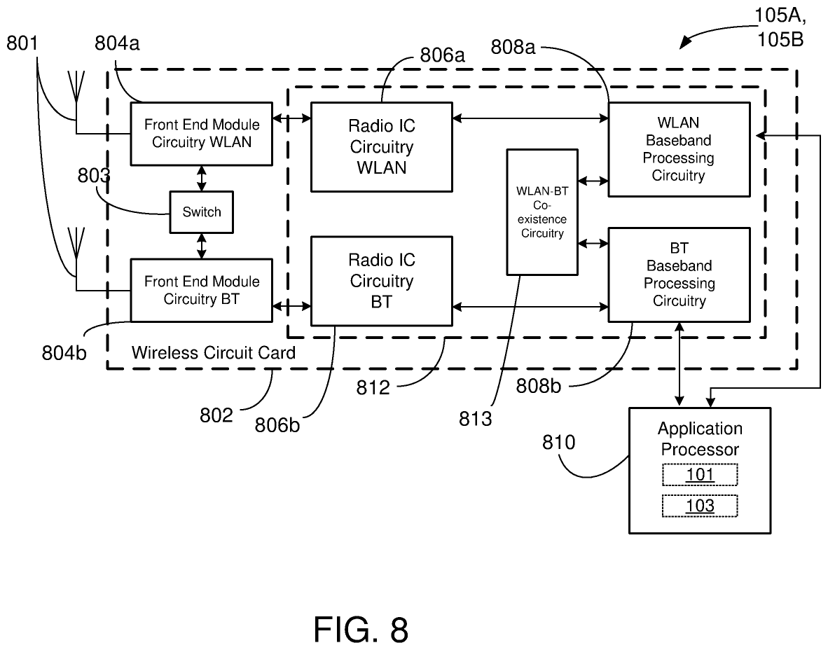

FIG. 8 is a block diagram of a radio architecture 105A, 105B in accordance with some embodiments that may be implemented in any one of the example APs 102 and/or the example user devices 120 of FIG. 1A. Radio architecture 105A, 105B may include radio front-end module (FEM) circuitry 804a-b, radio IC circuitry 806a-b and baseband processing circuitry 808a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 804a-b may include a WLAN or Wi-Fi FEM circuitry 804a and a Bluetooth (BT) FEM circuitry 804b. The WLAN FEM circuitry 804a may include a receive signal path comprising circuitry configured to operate on WLAN RF signals received from one or more antennas 801, to amplify the received signals and to provide the amplified versions of the received signals to the WLAN radio IC circuitry 806a for further processing. The BT FEM circuitry 804b may include a receive signal path which may include circuitry configured to operate on BT RF signals received from one or more antennas 801, to amplify the received signals and to provide the amplified versions of the received signals to the BT radio IC circuitry 806b for further processing. FEM circuitry 804a may also include a transmit signal path which may include circuitry configured to amplify WLAN signals provided by the radio IC circuitry 806a for wireless transmission by one or more of the antennas 801. In addition, FEM circuitry 804b may also include a transmit signal path which may include circuitry configured to amplify BT signals provided by the radio IC circuitry 806b for wireless transmission by the one or more antennas. In the embodiment of FIG. 8, although FEM 804a and FEM 804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 806a-b as shown may include WLAN radio IC circuitry 806a and BT radio IC circuitry 806b. The WLAN radio IC circuitry 806a may include a receive signal path which may include circuitry to down-convert WLAN RF signals received from the FEM circuitry 804a and provide baseband signals to WLAN baseband processing circuitry 808a. BT radio IC circuitry 806b may in turn include a receive signal path which may include circuitry to down-convert BT RF signals received from the FEM circuitry 804b and provide baseband signals to BT baseband processing circuitry 808b. WLAN radio IC circuitry 806a may also include a transmit signal path which may include circuitry to up-convert WLAN baseband signals provided by the WLAN baseband processing circuitry 808a and provide WLAN RF output signals to the FEM circuitry 804a for subsequent wireless transmission by the one or more antennas 801. BT radio IC circuitry 806b may also include a transmit signal path which may include circuitry to up-convert BT baseband signals provided by the BT baseband processing circuitry 808b and provide BT RF output signals to the FEM circuitry 804b for subsequent wireless transmission by the one or more antennas 801. In the embodiment of FIG. 8, although radio IC circuitries 806a and 806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 808a-b may include a WLAN baseband processing circuitry 808a and a BT baseband processing circuitry 808b. The WLAN baseband processing circuitry 808a may include a memory, such as, for example, a set of RAM arrays in a Fast Fourier Transform or Inverse Fast Fourier Transform block (not shown) of the WLAN baseband processing circuitry 808a. Each of the WLAN baseband circuitry 808a and the BT baseband circuitry 808b may further include one or more processors and control logic to process the signals received from the corresponding WLAN or BT receive signal path of the radio IC circuitry 806a-b, and to also generate corresponding WLAN or BT baseband signals for the transmit signal path of the radio IC circuitry 806a-b. Each of the baseband processing circuitries 808a and 808b may further include physical layer (PHY) and medium access control layer (MAC) circuitry, and may further interface with a device for generation and processing of the baseband signals and for controlling operations of the radio IC circuitry 806a-b.

Referring still to FIG. 8, according to the shown embodiment, WLAN-BT coexistence circuitry 813 may include logic providing an interface between the WLAN baseband circuitry 808a and the BT baseband circuitry 808b to enable use cases requiring WLAN and BT coexistence. In addition, a switch 803 may be provided between the WLAN FEM circuitry 804a and the BT FEM circuitry 804b to allow switching between the WLAN and BT radios according to application needs. In addition, although the antennas 801 are depicted as being respectively connected to the WLAN FEM circuitry 804a and the BT FEM circuitry 804b, embodiments include within their scope the sharing of one or more antennas as between the WLAN and BT FEMs, or the provision of more than one antenna connected to each of FEM 804a or 804b.

In some embodiments, the front-end module circuitry 804a-b, the radio IC circuitry 806a-b, and baseband processing circuitry 808a-b may be provided on a single radio card, such as wireless radio card 802. In some other embodiments, the one or more antennas 801, the FEM circuitry 804a-b and the radio IC circuitry 806a-b may be provided on a single radio card. In some other embodiments, the radio IC circuitry 806a-b and the baseband processing circuitry 808a-b may be provided on a single chip or integrated circuit (IC), such as IC 812.

In some embodiments, the wireless radio card 802 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 8, the BT baseband circuitry 808b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHZ, 5 GHZ, and bandwidths of about 2 MHZ, 4 MHz, 5 MHZ, 5.5 MHZ, 6 MHZ, 8 MHZ, 10 MHZ, 20 MHZ, 40 MHZ, 80 MHZ (with contiguous bandwidths) or 80+80 MHZ (160 MHZ) (with non-contiguous bandwidths). In some embodiments, a 920 MHz channel bandwidth may be used. The scope of the embodiments is not limited with respect to the above center frequencies.

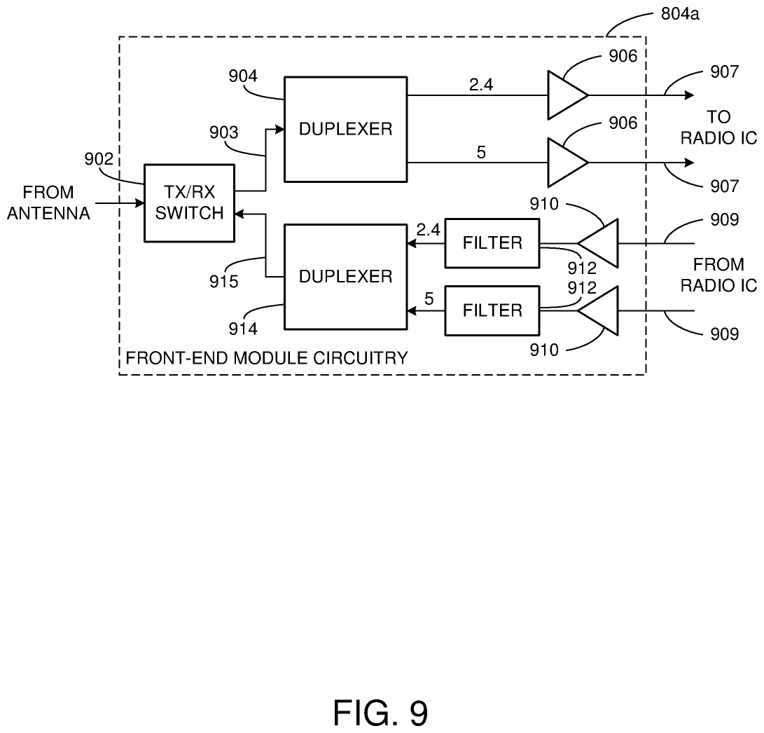

FIG. 9 illustrates WLAN FEM circuitry 904a in accordance with some embodiments. Although the example of FIG. 9 is described in conjunction with the WLAN FEM circuitry 804a, the example of FIG. 9 may be described in conjunction with the example BT FEM circuitry 804b (FIG. 13), although other circuitry configurations may also be suitable.

In some embodiments, the FEM circuitry 804a may include a TX/RX switch 902 to switch between transmit mode and receive mode operation. The FEM circuitry 804a may include a receive signal path and a transmit signal path. The receive signal path of the FEM circuitry 804a may include a low-noise amplifier (LNA) 906 to amplify received RF signals 903 and provide the amplified received RF signals 907 as an output (e.g., to the radio IC circuitry 806a-b (FIG. 8)). The transmit signal path of the circuitry 804a may include a power amplifier (PA) to amplify input RF signals 909 (e.g., provided by the radio IC circuitry 806a-b), and one or more filters 912, such as band-pass filters (BPFs), low-pass filters (LPFs) or other types of filters, to generate RF signals 915 for subsequent transmission (e.g., by one or more of the antennas 801 (FIG. 8)) via an example duplexer 914.

In some dual-mode embodiments for Wi-Fi communication, the FEM circuitry 804a may be configured to operate in either the 2.4 GHz frequency spectrum or the 5 GHz frequency spectrum. In these embodiments, the receive signal path of the FEM circuitry 804a may include a receive signal path duplexer 904 to separate the signals from each spectrum as well as provide a separate LNA 906 for each spectrum as shown. In these embodiments, the transmit signal path of the FEM circuitry 904a may also include a power amplifier 910 and a filter 912, such as a BPF, an LPF or another type of filter for each frequency spectrum and a transmit signal path duplexer 904 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

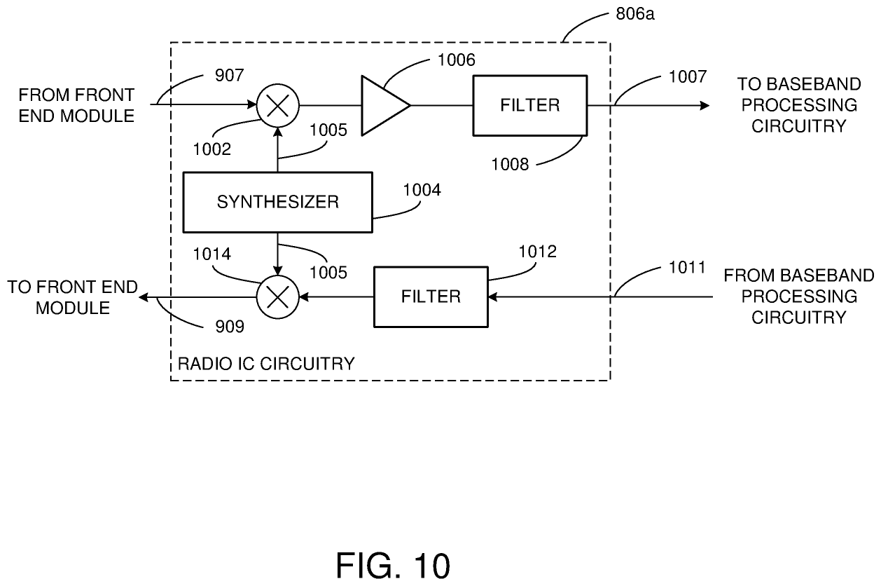

FIG. 10 illustrates radio IC circuitry 806a in accordance with some embodiments. The radio IC circuitry 806a is one example of circuitry that may be suitable for use as the WLAN or BT radio IC circuitry 806a/806b (FIG. 8), although other circuitry configurations may also be suitable. Alternatively, the example of FIG. 10 may be described in conjunction with the example BT radio IC circuitry 806b.

In some embodiments, the radio IC circuitry 806a may include a receive signal path and a transmit signal path. The receive signal path of the radio IC circuitry 806a may include at least mixer circuitry 1002, such as, for example, down-conversion mixer circuitry, amplifier circuitry 1006 and filter circuitry 1008. The transmit signal path of the radio IC circuitry 806a may include at least filter circuitry 1012 and mixer circuitry 1014, such as, for example, up-conversion mixer circuitry. Radio IC circuitry 806a may also include synthesizer circuitry 1004 for synthesizing a frequency 1005 for use by the mixer circuitry 1002 and the mixer circuitry 1014. The mixer circuitry 1002 and/or 1014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 10 illustrates only a simplified version of a radio IC circuitry, and may include, although not shown, embodiments where each of the depicted circuitries may include more than one component. For instance, mixer circuitry 1014 may each include one or more mixers, and filter circuitries 1008 and/or 1012 may each include one or more filters, such as one or more BPFs and/or LPFs according to application needs. For example, when mixer circuitries are of the direct-conversion type, they may each include two or more mixers.

In some embodiments, mixer circuitry 1002 may be configured to down-convert RF signals 907 received from the FEM circuitry 804a-b (FIG. 8) based on the synthesized frequency 1005 provided by synthesizer circuitry 1004. The amplifier circuitry 1006 may be configured to amplify the down-converted signals and the filter circuitry 1008 may include an LPF configured to remove unwanted signals from the down-converted signals to generate output baseband signals 1007. Output baseband signals 1007 may be provided to the baseband processing circuitry 808a-b (FIG. 8) for further processing. In some embodiments, the output baseband signals 1007 may be zero-frequency baseband signals, although this is not a requirement. In some embodiments, mixer circuitry 1002 may comprise passive mixers, although the scope of the embodiments is not limited in this respect.

In some embodiments, the mixer circuitry 1014 may be configured to up-convert input baseband signals 1011 based on the synthesized frequency 1005 provided by the synthesizer circuitry 1004 to generate RF output signals 1009 for the FEM circuitry 804a-b. The baseband signals 1011 may be provided by the baseband processing circuitry 808a-b and may be filtered by filter circuitry 1012. The filter circuitry 1012 may include an LPF or a BPF, although the scope of the embodiments is not limited in this respect.

In some embodiments, the mixer circuitry 1002 and the mixer circuitry 1014 may each include two or more mixers and may be arranged for quadrature down-conversion and/or up-conversion respectively with the help of synthesizer 1004. In some embodiments, the mixer circuitry 1002 and the mixer circuitry 1014 may each include two or more mixers each configured for image rejection (e.g., Hartley image rejection). In some embodiments, the mixer circuitry 1002 and the mixer circuitry 1014 may be arranged for direct down-conversion and/or direct up-conversion, respectively. In some embodiments, the mixer circuitry 1002 and the mixer circuitry 1014 may be configured for super-heterodyne operation, although this is not a requirement.

Mixer circuitry 1002 may comprise, according to one embodiment: quadrature passive mixers (e.g., for the in-phase (I) and quadrature phase (Q) paths). In such an embodiment, RF input signal 907 from FIG. 9 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1005 of synthesizer 1004 (FIG. 10). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 907 (FIG. 94) may comprise a balanced signal, although the scope of the embodiments is not limited in this respect. The I and Q baseband output signals may be provided to low-noise amplifier, such as amplifier circuitry 1006 (FIG. 10) or to filter circuitry 1008 (FIG. 10).

In some embodiments, the output baseband signals 1007 and the input baseband signals 1011 may be analog baseband signals, although the scope of the embodiments is not limited in this respect. In some alternate embodiments, the output baseband signals 1007 and the input baseband signals 1011 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1004 may be a fractional-N synthesizer or a fractional N/N+1 synthesizer, although the scope of the embodiments is not limited in this respect as other types of frequency synthesizers may be suitable. For example, synthesizer circuitry 1004 may be a delta-sigma synthesizer, a frequency multiplier, or a synthesizer comprising a phase-locked loop with a frequency divider. According to some embodiments, the synthesizer circuitry 1004 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1004 may be provided by a voltage controlled oscillator (VCO), although that is not a requirement. A divider control input may further be provided by either the baseband processing circuitry 808a-b (FIG. 8) depending on the desired output frequency 1005. In some embodiments, a divider control input (e.g., N) may be determined from a look-up table (e.g., within a Wi-Fi card) based on a channel number and a channel center frequency as determined or indicated by the example application processor 810. The application processor 810 may include, or otherwise be connected to, one of the example secure signal converter 101 or the example received signal converter 103 (e.g., depending on which device the example radio architecture is implemented in).

In some embodiments, synthesizer circuitry 1004 may be configured to generate a carrier frequency as the output frequency 1005, while in other embodiments, the output frequency 1005 may be a fraction of the carrier frequency (e.g., one-half the carrier frequency, one-third the carrier frequency). In some embodiments, the output frequency 1005 may be a LO frequency (fLO).

FIG. 11 illustrates a functional block diagram of baseband processing circuitry 808a in accordance with some embodiments. The baseband processing circuitry 808a is one example of circuitry that may be suitable for use as the baseband processing circuitry 808a (FIG. 8), although other circuitry configurations may also be suitable. Alternatively, the example of FIG. 11 may be used to implement the example BT baseband processing circuitry 808b of FIG. 8.

The baseband processing circuitry 808a may include a receive baseband processor (RX BBP) 1102 for processing receive baseband signals 909 provided by the radio IC circuitry 806a-b (FIG. 8) and a transmit baseband processor (TX BBP) 1104 for generating transmit baseband signals 1011 for the radio IC circuitry 806a-b. The baseband processing circuitry 808a may also include control logic 1106 for coordinating the operations of the baseband processing circuitry 808a.

In some embodiments (e.g., when analog baseband signals are exchanged between the baseband processing circuitry 808a-b and the radio IC circuitry 806a-b), the baseband processing circuitry 808a may include ADC 1110 to convert analog baseband signals 1109 received from the radio IC circuitry 806a-b to digital baseband signals for processing by the RX BBP 1102. In these embodiments, the baseband processing circuitry 808a may also include DAC 1112 to convert digital baseband signals from the TX BBP 1104 to analog baseband signals 1111.

In some embodiments that communicate OFDM signals or OFDMA signals, such as through baseband processor 808a, the transmit baseband processor 1104 may be configured to generate OFDM or OFDMA signals as appropriate for transmission by performing an inverse fast Fourier transform (IFFT). The receive baseband processor 1102 may be configured to process received OFDM signals or OFDMA signals by performing an FFT. In some embodiments, the receive baseband processor 1102 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 8, in some embodiments, the antennas 801 (FIG. 8) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 801 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors. DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device.” “user device,” “communication station,” “station,” “handheld device.” “mobile device.” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating.” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second.” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.
Example 1 may be an apparatus of a MLD for performing Wi-Fi low-latency operations, the apparatus comprising processing circuitry coupled to storage, the processing circuitry configured to: generate a first physical layer (PHY) protocol data unit (PPDU); transmit, using a first station device of the MLD, the first PPDU during a transmission opportunity (TXOP) scheduled between the first station device of the MLD and a second station device of a second MLD: identify a frame received by the first station device after transmission of the first PPDU, the frame indicative of a request for the second station device or a third station device to transmit time-sensitive data to the first station device: identify the time-sensitive data received by the first station device after transmission of the first PPDU and prior to the first station device transmitting a second PPDU during the TXOP: transmit, using the first station device, after transmission of the first PPDU and prior to the first station device transmitting the second PPDU during the TXOP, an acknowledgement indicative of receipt of the time-sensitive data by the first station device: generate the second PPDU; and transmit, using the first station device, the second PPDU after transmission of the acknowledgement and during the TXOP.
Example 2 may include the apparatus of example 1 and/or some other example herein, wherein the MLD is an access point MLD (A-MLD) comprising the first station device and at least one additional station device, and wherein the second MLD is a non-access point MLD.
Example 3 may include the apparatus of example 2 and/or some other example herein, wherein the frame is a suspend request frame, and wherein the processing circuitry is further configured to: transmit, using the first station device, a trigger frame, wherein the time-sensitive data are received based on the trigger frame.
Example 4 may include the apparatus of example 3 and/or some other example herein, wherein the processing circuitry is further configured to: generate a third PPDU; and transmit, using the first station device, the third PPDU prior to transmitting the trigger frame.
Example 5 may include the apparatus of example 5 and/or some other example herein, wherein the trigger frame is transmitted between the third PPDU and the second PPDU.
Example 6 may include the apparatus of example 1 or 2 and/or some other example herein, wherein a first preamble of the first PPDU is longer than a second preamble of the second PPDU.
Example 7 may include the apparatus of example 1 and/or some other example herein, wherein the MLD is a non-access point MLD comprising the first station device and at least one additional station device, and wherein the second MLD is an A-MLD.
Example 8 may include the apparatus of example 7 and/or some other example herein, wherein the frame is a combined acknowledgement and suspend request frame, and wherein the processing circuitry is further configured to: identify a trigger frame received by the second station device or the third station device, wherein the second PPDU is transmitted based on the trigger frame.
Example 9 may include the apparatus of example 8 and/or some other example herein, wherein the second PPDU is transmitted based on the trigger frame.
Example 10 may include the device of any of examples 1-9 and/or some other example herein, further comprising a transceiver configured to transmit and receive wireless signals comprising the first PPDU, the second PPDU, the frame, and the time-sensitive data.
Example 11 may include the device of example 10 and/or some other example herein, further comprising one or more antennas coupled to the transceiver to transmit the wireless signals.
Example 12 may include a computer-readable storage medium comprising instructions to cause processing circuitry of a multi-link device (MLD), upon execution of the instructions by the processing circuitry, to: generate a first physical layer (PHY) protocol data unit (PPDU); transmit, using a first station device of the MLD, the first PPDU during a transmission opportunity (TXOP) scheduled between the first station device of the MLD and a second station device of a second MLD: identify a frame received by the first station device after transmission of the first PPDU, the frame indicative of a request for the second station device or a third station device to transmit time-sensitive data to the first station device: identify the time-sensitive data received by the first station device after transmission of the first PPDU and prior to the first station device transmitting a second PPDU during the TXOP: transmit, using the first station device, after transmission of the first PPDU and prior to the first station device transmitting the second PPDU during the TXOP, an acknowledgement indicative of receipt of the time-sensitive data by the first station device: generate the second PPDU; and transmit, using the first station device, the second PPDU after transmission of the acknowledgement and during the TXOP.
Example 13 may include the computer-readable medium of example 12 and/or some other example herein, x wherein the MLD is an access point MLD (A-MLD) comprising the first station device and at least one additional station device, and wherein the second MLD is a non-access point MLD Xx.
Example 14 may include the computer-readable medium of example 13 and/or some other example herein, wherein the frame is a suspend request frame, and wherein execution of the instructions further causes to processing circuitry to: transmit, using the first station device, a trigger frame, wherein the time-sensitive data are received based on the trigger frame.
Example 15 may include the computer-readable medium of example 14 and/or some other example herein, wherein execution of the instructions further causes to processing circuitry to: generate a third PPDU; and transmit, using the first station device, the third PPDU prior to transmitting the trigger frame.
Example 16 may include the computer-readable medium of example 15 and/or some other example herein, wherein the trigger frame is transmitted between the third PPDU and the second PPDU.
Example 17 may include the computer-readable medium of example 12 or 13 and/or some other example herein, wherein a first preamble of the first PPDU is longer than a second preamble of the second PPDU.
Example 18 may include the computer-readable medium of example 12 and/or some other example herein, wherein the MLD is a non-access point MLD comprising the first station device and at least one additional station device, and wherein the second MLD is an A-MLD.
Example 19 may include the computer-readable medium of example 18 and/or some other example herein, wherein the frame is a combined acknowledgement and suspend request frame, and wherein execution of the instructions further causes to processing circuitry to: identify a trigger frame received by the second station device or the third station device, wherein the second PPDU is transmitted based on the trigger frame.
Example 20 may include the computer-readable medium of example 19 and/or some other example herein, wherein the second PPDU is transmitted based on the trigger frame.
Example 21 may include a method for performing Wi-Fi low-latency operations, the method comprising: generating, by processing circuitry of a first multi-link device (MLD), a first physical layer (PHY) protocol data unit (PPDU): transmitting, by the processing circuitry, using a first station device of the MLD, the first PPDU during a transmission opportunity (TXOP) scheduled between the first station device of the first MLD and a second station device of a second MLD: identifying, by the processing circuitry, a frame received by the first station device after transmission of the first PPDU, the frame indicative of a request for the second station device or a third station device to transmit time-sensitive data to the first station device; identifying, by the processing circuitry, the time-sensitive data received by the first station device after transmission of the first PPDU and prior to the first station device transmitting a second PPDU during the TXOP: transmitting, by the processing circuitry, using the first station device, after transmission of the first PPDU and prior to the first station device transmitting the second PPDU during the TXOP, an acknowledgement indicative of receipt of the time-sensitive data by the first station device: generating, by the processing circuitry, the second PPDU; and transmitting, by the processing circuitry, using the first station device, the second PPDU after transmission of the acknowledgement and during the TXOP.
Example 22 may include the method of example 21 and/or some other example herein, wherein the first MLD is an access point MLD (A-MLD) comprising the first station device and at least one additional station device, and wherein the second MLD is a non-access point MLD.
Example 23 may include the method of example 22 and/or some other example herein, wherein the frame is a suspend request frame, the method further comprising: transmitting, using the first station device, a trigger frame, wherein the time-sensitive data are received based on the trigger frame.
Example 24 may include the method of example 23 and/or some other example herein, generating a third PPDU; and transmitting, using the first station device, the third PPDU prior to transmitting the trigger frame.
Example 25 may include the method of example 24 and/or some other example herein, wherein the trigger frame is transmitted between the third PPDU and the second PPDU.
Example 26 may include an apparatus comprising means for: generating, by a first multi-link device (MLD), a first physical layer (PHY) protocol data unit (PPDU): transmitting, using a first station device of the MLD, the first PPDU during a transmission opportunity (TXOP) scheduled between the first station device of the first MLD and a second station device of a second MLD: identifying a frame received by the first station device after transmission of the first PPDU, the frame indicative of a request for the second station device or a third station device to transmit time-sensitive data to the first station device: identifying the time-sensitive data received by the first station device after transmission of the first PPDU and prior to the first station device transmitting a second PPDU during the TXOP: transmitting, using the first station device, after transmission of the first PPDU and prior to the first station device transmitting the second PPDU during the TXOP, an acknowledgement indicative of receipt of the time-sensitive data by the first station device: generating the second PPDU; and transmitting, using the first station device, the second PPDU after transmission of the acknowledgement and during the TXOP.
Example 27 may include one or more non-transitory computer-readable media comprising instructions to cause an electronic device, upon execution of the instructions by one or more processors of the electronic device, to perform one or more elements of a method described in or related to any of examples 1-26, or any other method or process described herein.
Example 28 may include an apparatus comprising logic, modules, and/or circuitry to perform one or more elements of a method described in or related to any of examples 1-26, or any other method or process described herein.
Example 29 may include a method, technique, or process as described in or related to any of examples 1-26, or portions or parts thereof.
Example 30 may include an apparatus comprising: one or more processors and one or more computer readable media comprising instructions that, when executed by the one or more processors, cause the one or more processors to perform the method, techniques, or process as described in or related to any of examples 1-26, or portions thereof.
Example 31 may include a method of communicating in a wireless network as shown and described herein.
Example 32 may include a system for providing wireless communication as shown and described herein.
Example 33 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can.” “could.” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of a multi-link device (MLD) for performing Wi-Fi low-latency operations, the apparatus comprising processing circuitry coupled to storage, the processing circuitry configured to:
generate a first physical layer (PHY) protocol data unit (PPDU);
transmit, using a first station device of the MLD, the first PPDU during a transmission opportunity (TXOP) scheduled between the first station device of the MLD and a second station device of a second MLD;
identify a frame received by the first station device after transmission of the first PPDU, the frame indicative of a request for the second station device or a third station device to transmit time-sensitive data to the first station device;
identify the time-sensitive data received by the first station device after transmission of the first PPDU and prior to the first station device transmitting a second PPDU during the TXOP;
transmit, using the first station device, after transmission of the first PPDU and prior to the first station device transmitting the second PPDU during the TXOP, an acknowledgement indicative of receipt of the time-sensitive data by the first station device;
generate the second PPDU; and
transmit, using the first station device, the second PPDU after transmission of the acknowledgement and during the TXOP.

2. The apparatus of claim 1, wherein the MLD is an access point MLD (A-MLD) comprising the first station device and at least one additional station device, and wherein the second MLD is a non-access point MLD.

3. The apparatus of claim 2, wherein the frame is a suspend request frame, and wherein the processing circuitry is further configured to:
transmit, using the first station device, a trigger frame,
wherein the time-sensitive data are received based on the trigger frame.

4. The apparatus of claim 3, wherein the processing circuitry is further configured to:
generate a third PPDU; and
transmit, using the first station device, the third PPDU prior to transmitting the trigger frame.

5. The apparatus of claim 4, wherein the trigger frame is transmitted between the third PPDU and the second PPDU.

6. The apparatus of claim 2, wherein a first preamble of the first PPDU is longer than a second preamble of the second PPDU.

7. The apparatus of claim 1, wherein the MLD is a non-access point MLD comprising the first station device and at least one additional station device, and wherein the second MLD is an A-MLD.

8. The apparatus of claim 7, wherein the frame is a combined acknowledgement and suspend request frame, and wherein the processing circuitry is further configured to:
identify a trigger frame received by the second station device or the third station device,
wherein the second PPDU is transmitted based on the trigger frame.

9. The apparatus of claim 8, wherein the second PPDU is transmitted based on the trigger frame.

10. The apparatus of claim 9, further comprising a transceiver configured to transmit and receive wireless signals comprising the first PPDU, the second PPDU, the frame, and the time-sensitive data.

11. The apparatus of claim 10, further comprising an antenna coupled to the transceiver to transmit the wireless signals.

12. A non-transitory computer-readable storage medium comprising instructions to cause processing circuitry of a multi-link device (MLD), upon execution of the instructions by the processing circuitry, to:
generate a first physical layer (PHY) protocol data unit (PPDU);
transmit, using a first station device of the MLD, the first PPDU during a transmission opportunity (TXOP) scheduled between the first station device of the MLD and a second station device of a second MLD;
identify a frame received by the first station device after transmission of the first PPDU, the frame indicative of a request for the second station device or a third station device to transmit time-sensitive data to the first station device;
identify the time-sensitive data received by the first station device after transmission of the first PPDU and prior to the first station device transmitting a second PPDU during the TXOP;
transmit, using the first station device, after transmission of the first PPDU and prior to the first station device transmitting the second PPDU during the TXOP, an acknowledgement indicative of receipt of the time-sensitive data by the first station device;
generate the second PPDU; and
transmit, using the first station device, the second PPDU after transmission of the acknowledgement and during the TXOP.

13. The non-transitory computer-readable storage medium of claim 12,
wherein the MLD is an access point MLD (A-MLD) comprising the first station device and at least one additional station device, and wherein the second MLD is a non-access point MLD.

14. The non-transitory computer-readable storage medium of claim 13, wherein the frame is a suspend request frame, and wherein execution of the instructions further causes to processing circuitry to:
transmit, using the first station device, a trigger frame, and
wherein the time-sensitive data are received based on the trigger frame.

15. The non-transitory computer-readable storage medium of claim 14, wherein execution of the instructions further causes to processing circuitry to:
generate a third PPDU; and
transmit, using the first station device, the third PPDU prior to transmitting the trigger frame.

16. The non-transitory computer-readable storage medium of claim 15, wherein the trigger frame is transmitted between the third PPDU and the second PPDU.

17. The non-transitory computer-readable storage medium of claim 13, wherein a first preamble of the first PPDU is longer than a second preamble of the second PPDU.

18. The non-transitory computer-readable storage medium of claim 12, wherein the MLD is a non-access point MLD comprising the first station device and at least one additional station device, and wherein the second MLD is an A-MLD.

19-20. (canceled)

21. A method for performing Wi-Fi low-latency operations, the method comprising:
generating, by processing circuitry of a first multi-link device (MLD), a first physical layer (PHY) protocol data unit (PPDU);
transmitting, by the processing circuitry, using a first station device of the MLD, the first PPDU during a transmission opportunity (TXOP) scheduled between the first station device of the first MLD and a second station device of a second MLD;
identifying, by the processing circuitry, a frame received by the first station device after transmission of the first PPDU, the frame indicative of a request for the second station device or a third station device to transmit time-sensitive data to the first station device;
identifying, by the processing circuitry, the time-sensitive data received by the first station device after transmission of the first PPDU and prior to the first station device transmitting a second PPDU during the TXOP;
transmitting, by the processing circuitry, using the first station device, after transmission of the first PPDU and prior to the first station device transmitting the second PPDU during the TXOP, an acknowledgement indicative of receipt of the time-sensitive data by the first station device;
generating, by the processing circuitry, the second PPDU; and
transmitting, by the processing circuitry, using the first station device, the second PPDU after transmission of the acknowledgement and during the TXOP.

22. The method of claim 21, wherein the first MLD is an access point MLD (A-MLD) comprising the first station device and at least one additional station device, and wherein the second MLD is a non-access point MLD.

23-25. (canceled)
